(19) United States
(12) Patent Application Publication
(10) Pub. No.: US 2007/0135552 A1
(43) Pub. Date: Jun. 14, 2007

(54) Gas barrier

(75) Inventors: Matthew B. Wrosch, San Diego, CA (US); Andre R. Klein, San Diego, CA (US)

Correspondence Address: James J. Schumann;Fitch, Even, Tabin & Flannery, Suite 1600, 120 South LaSalle Street, Chicago, IL, 60603-3406, US

(73) Assignee: General Atomics, San Diego, CA (US)

(21) Appl. No.: 11/298,916

(22) Filed: Dec. 9, 2005

(51) Int. Cl. C08K 3/34

(52) U.S. Cl. 524/443; 524/429; 977/776

(57) ABSTRACT

Nanoparticles of amorphous aluminum oxynitride or silicon oxynitride having a very high aspect ratio are used to fill polymeric materials to provide products that have an extremely low WVTR/OTR. Such products are particularly effective for incorporation into organic light-emitting devices or the like which are susceptible to degradation from moisture and/or oxygen. Pressure sensitive and/or thermosetting adhesives filled with such particles create excellent sealants. Polymeric sheets or films made from resin in which these nanoparticles are dispersed, or intimately associated with, before extrusion exhibit very low WVTR/OTR.

### FIELD OF THE INVENTION

This invention relates to gas barriers with nanoparticles. More particularly, the invention relates to polymeric gas barriers which have improved resistance to oxygen and/or water vapor transmission as a result of the inclusion of nanoparticles which create a tortuous path through the polymeric material.

### BACKGROUND OF INVENTION

Electronic display devices are used to exhibit electronically generated graphical and textual images, and there are a variety of types of such electronic displays, with more under development. Among the more familiar types of electronic displays, are: liquid crystal displays (“LCDs”); arrays of light-emitting diodes (“LEDs”); organic light-emitting diodes (OLEDs); plasma display panels (“PDP”); field emission displays (“FED”); and electroluminescent (“EL”) displays. As electronics become more and more miniaturized, there has been an increased demand for portable devices, and LCDs, LEDs, OLEDs and EL displays are particularly useful in such portable electronic devices due to their light weight and low power consumption relative to other display technologies.

The basic LCD unit is a cell made of two transparent sheets (referred to in the art as substrates) having conductive coatings; the coated sheets are sandwiched together with an adhesive cell-sealing material along the edge and filled with liquid crystal and spacers. Additional components which may be included in a liquid crystal display cell include, for example, alignment layers used to align the liquid crystal fluid, color filter coatings, active electronic devices such as thin film transistors, and polarizers. EL displays are generally composed of at least one transparent substrate having a conductive coating and make use of electroluminescent phosphors as the image generating medium. LEDs and OLEDs are generally similar in having at least one transparent substrate having a conductive coating which serves as an electrode, usually the cathode. Electronic devices made with these types of displays often include other electronic components, such as drivers, which are used to generate the image on the electronic display.

Substrates for earlier versions of such display devices were typically made of optical quality glass or quartz, because these materials met requirements for optical clarity and flatness and had good gas and moisture barrier properties. However, glass and quartz are brittle and subject to breakage, and they are therefore limited in usefulness where an application requires thin sheets or films less than 1 mm in thickness. Accordingly, various plastics have been proposed as replacement substrates because they are lighter in weight, may be readily formed into thin films, as by extrusion, and are flexible. Such materials include, for example, thermoplastic resins such as polyacrylates, polyesters, polysulfones, polycarbonates and polyamides.

U.S. Pat. No. 4,802,742 (Ichikawa et al) describes the use of certain plastics, such as polyethersulfone and polycarbonate, as plastic substrate materials for LCDs. Polycarbonate has a higher visible light transmission than polyethersulfone and may be preferred for some applications. Electronic displays made with such types of plastic substrate materials have been under development for several decades, but they have enjoyed only limited commercial success because all of these plastics have limitations with respect to optical quality and gas barrier properties. Because moisture barrier properties of such materials are unsatisfactory, microelectric device manufacturers have attempted to control the environment within a packaged OLED device or the like by encapsulating the device along with a desiccant package that will contain solid material effective to absorb water, such as molecular sieve materials, silica gel materials and the like. However, particular microelectronic devices require such low humidity conditions that they might not be achievable through the inclusion of reasonable amounts of such gettering materials; as a result, other solutions have been pursued and improvements in them have been sought. Often manufacturers have striven to reduce H₂O and O₂ transmission rates (WVTR/OTR) to levels of 1×10⁻⁶/m² day and below, and improving such properties of adhesive layers and polymeric barrier sheets has become a priority.

U.S. Pat. No. 4,618,528 to Sacks, et al. discusses earlier British and French patents that used platelike fillers of mica, graphite or talc in polymers to increase resistance to gas diffusion, and it discloses the use of high density polyethylene films that are filled with a platelet filler such as talc, e.g. 29% talc.

U.S. Pat. No. 4,938,432 to Bissot teaches the use of a multi-layer structure wherein one layer contains 5-50% by weight of mica in platelet shape.

U.S. Pat. No. 5,700,560 to Kotani, et al. discloses a gas barrier film wherein an inorganic laminar compound, e.g. synthetic terrasililic mica, having a particle size of 5 microns and an aspect ratio of 50-5,000 was dispersed in PVA or triacetylcellulose resins. The platelets generally used in the examples are clay or a synthetic clay.

U.S. Pat. No. 6,627,324 to Eggers, et al. alleges the production of a transparent film containing solid nanoscale filling materials. The film is a laminate wherein the particles are platelets of sheet silicates, such as magnesium or aluminum silicate, or synthetic clays or synthetic analogs thereof, which are preferably less than 10 nm thick. It appears that nanoparticles are being used for the provision of other physical properties in addition to providing a tortuous path gas barrier in a multi-layer film.

U.S. Pat. No. 6,479,160 to Tsai, et al. employs clay platelets with a thickness from 1 nm to 100 nm in an amount up to about 10% by weight to provide an ultrahigh oxygen barrier in an EVOH co-polymer. U.S. Pat. No. 6,793,994 to Tsai, et al. also employs nanoclays and is similar.

U.S. Pat. No. 6,790,896 to Chaiko uses edge-modified phyllosilicates as mineral fillers for polymeric films and, in the introduction, discusses approaches that had been taken to date to use organoclays for this purpose.

U.S. Patent Application Publication No. 2004/0260000 to Chaiko appears to be a follow-on of the patent mentioned above which uses edge-modified organoclays.

U.S. Pat. No. 6,841,211 to Knoll, et al. discloses a soft drink bottle or the like of multilayer construction where there is an improved oxygen barrier layer in the form of a nylon nanocomposite which is based upon clay nanoparticles.

U.S. Pat. No. 5,916,685 to Frisk discloses a transparent multilayer structure for fruit juice or the like which has superior barrier properties to oxygen and water vapor and which includes a polymer layer containing up to 10% of a clay material. The product is alleged to be the answer to eliminating the weight of present day glass bottles. Details of the clay nanoparticles are set forth in the paragraph at Column 4, lines 26-31. U.S. Pat. No. 5,876,812 to Frisk, et al. focuses more upon the clay nanoparticles and says that the montmorillonite species of smectite clays which have a specific thickness and aspect ratio are preferred.

U.S. Pat. No. 6,863,851 teaches processes for producing Angstrom-scale flakes or platelets that can be used for both functional and decorative applications, which flakes can be in the nanoscale range. Although reflective metal flakes are the prime objective of the patent, it is mentioned that they can be used in electrical insulating and barrier applications. Multiple layers are vapor deposited under vacuum deposition conditions separated by polymeric release layers which are subsequently vaporized or solvent-dissolved. The multilayer sandwiches may be subjected to grinding to provide rough flakes from which release coat material is dissolved by solvent; the flakes may then be further sized to provide particles having an aspect ratio of about 100 to 1 to about 300 to 1.

Such improvements in barrier sheets have not produced totally satisfactory solutions, and as a result, many manufacturers have continued to provide such display devices which include a pocket of desiccant somewhere within the packaged device in order to getter moisture that eventually finds its way through the barrier layers. Emphasis has also become focused on the adhesives being used for sealing.

U.S. Pat. No. 4,081,397 teaches the use of alkaline earth oxides, such as barium or calcium oxide and desiccants in an elastomeric matrix to serve as a closure to preserve the performance of an electronic device. U.S. Pat. No. 5,047,687 proposes the similar inclusion of water-absorbing metal particles which are oxidized by ambient moisture to protect electroluminescent devices.

U.S. Pat. No. 5,304,419 taught improved adhesives for electronic device packaging where pressure sensitive adhesives were formulated to contain 4-40% by volume of a solid desiccant. U.S. Pat. No. 6,080,350 is entitled “Desiccant Entrained Polymer”; it entrains a desiccating agent in a molten polymer designed to form plug-type inserts and the like. U.S. Pat. No. 6,226,890 describes using solid desiccant particles of 200 microns or less as part of a castable material which can be used to form a desiccant layer over a flange opening or the like for such a microelectronic device. U.S. Pat. No. 6,740,145 taught that particles of calcium oxide of a size less than about 0.1 micron dispersed in a meltable polyamide material provide good protection against water vapor transmission. U.S. Pat. No. 6,589,625 uses adhesives mixed with zeolites to create a seal along the edge of glass plates that provide an electronic display screen. U.S. Pat. Nos. 6,835,950 and 6,897,474 teach the protection of OLEDs through the use of overall layers of pressure sensitive adhesive to adhere barrier films as protection to provide improved WVTR/OTR; these pressure sensitive adhesive layers may include dispersed getter materials, such as desiccants and the like.

Despite the many efforts in this area, totally satisfactory gas barrier materials and arrangements have not been achieved. Thus, there remains a need for adhesives and filled polymeric materials which have good optical quality and further improved gas barrier properties, and the search for same has continued.

### SUMMARY OF THE INVENTION

The invention provides unique nanoparticles of aluminum and/or silicon oxynitride material which are amorphous, as opposed to having a defined crystalline order, and which are preferably in the form of substantially flat platelets having a thickness between about 100 and about 1000 Angstroms (ANG) and preferably between about 300 to about 800 ANG. The nanoparticles are preferably sized to have an aspect ratio between about 3,000 to 1 and about 50,000 to 1. Platelet nanoparticles of this material and aspect ratio have been found to be excellently suited for creating a tortuous path in a polymeric matrix that greatly delays the transmission of gases, such as oxygen and water vapor, from an exterior surface of the polymeric material that will be exposed to the atmosphere to an opposite interior surface thereof. Whereas it had previously been thought that nanoparticles of particularly small size were superior, improved resistance to water vapor transmission has been found to flow from nanoparticles of these materials having a very high aspect ratio.

In a more particular aspect, the invention provides articles useful in creating transparent polymeric gas diffusion barrier materials, which particles comprise nanoscale particles formed of amorphous aluminum and/or silicon oxynitrides having an aspect ratio of between about 3,000 to 1 and about 50,000 to 1 and a thickness between about 100 ANG and 1,000 ANG, said particles being transparent to both visible and UV light and having no defined crystalline structure, and said particles when present in polymeric material in an amount of at least about 1 weight % causing the WVTR and the OTR of the polymeric material to be reduced by at least about 30%.

The invention also provides adhesive compositions and polymeric composites (in sheet or other form) where dispersed throughout are nanoparticles of amorphous aluminum and/or silicon oxynitrides of an appropriate thickness and aspect ratio which are highly impermeable to gases, particularly oxygen and water vapor, so the resultant filled materials exhibit very low WVTR/OTR. Any of a variety of polymeric materials can be filled with such nanoparticles; however, polymeric materials which inherently exhibit some reasonable resistance to the gas transmission are preferred.

In addition, the invention provides a method for preparing such nanocomposite materials by (a) relatively uniformly dispersing an appropriate amount of such aluminum and/or silicon oxynitride nanoparticles in a polymer and then extruding such polymer to form such sheetlike composite materials, or (b) dispersing such nanoparticles in an appropriate concentration in one component of a 2-component organic polymeric adhesive composition or in a thinned polymeric adhesive composition. Such sheets and such cured/hardened adhesive materials are products which exhibit substantially reduced permeability to gases, such as oxygen and water vapor, generally by at least about 30% and preferably by at least about 50% compared to the comparable unfilled polymer; often reductions in permeation of five-fold or more will be effected.

### BRIEF DESCRIPTION OF THE DRAWINGS

FIG. 1 is a schematic view of a protected light-emitting device embodying various features of the invention.

### DETAILED DESCRIPTION OF THE PREFERRED EMBODIMENTS

As used in this specification, the following terms have the following definitions, unless the context clearly indicates otherwise. “Polymer” refers to thermoplastic and thermosetting polymers and like organic polymers, which are suitable to create curable adhesives and/or to form sheets; the terms “polymer” and “resin” may be used interchangeably throughout this specification. “Sheet” and “sheetlike” refer to a sheet having a thickness of about 25 mm or less, and such term is intended to include “films” (which are herein considered to be sheets having a thickness of about <0.5 mm or less). By “aspect ratio” is meant the ratio of average particle size divided by average particle thickness. The following abbreviations are used in the specification: mm=millimeter(s); nm=nanometer(s); μ=micron(s) (micrometer); ANG=Angstrom(s) (10⁻¹⁰ meter); g=gram(s); UV=ultraviolet; PMMA=polymethylmethacrylate; ITO=indium-tin oxide; OTR=oxygen transmission rate; and WVTR=water vapor transmission rate. All temperature references are ° C. unless otherwise specified. Ranges specified are to be read as inclusive, unless specifically identified otherwise.

It is found that unique particles of aluminum or silicon oxynitride of nanoparticle scale are effective in imparting, to polymeric materials, high resistance to the transmission of water vapor and oxygen; they can be employed as fillers for dispersion throughout such polymers to effect such an end result. The nanoparticles may be made of silicon oxynitride, aluminum oxynitride, or silicon aluminum oxynitride. Typically these oxynitrides do not exhibit a stoichiometric composition, and accordingly, the formulas are generally given as SiOₓN_{y}, AlOₓN_{y}, and SiAlOₓN_{y} where x is between about 2.5 and 3, and y is between about 1.5 and 2 based upon one mole of silicon, or aluminum, or one mole total of silicon plus aluminum for the last of the three compositions. Furthermore, when SiAlOₓN_{y} is used, the ratio of silicon to aluminum is between about 1 to 2.5 mole of Si to one mole of Al. The nanoparticles should be substantially flat platelets of a very high aspect ratio. Their thickness should be between about 80 and about 1000 ANG, and preferably about 100 to about 800 ANG, and the aspect ratio of these platelets should be between about 3,000 to 1 and about 50,000 to 1. The materials are manufactured so as to have an amorphous, noncrystalline form; as such, they inherently exhibit high resistance to the permeation of both water vapor and oxygen. They are highly effective in creating a tortuous path in a polymeric material that effectively deters the transmission of oxygen and/or humidity therethrough. Thus, they are extremely useful in creating polymeric adhesives and/or sealants, as well as providing filled polymeric sheet materials, particularly films, that exhibit improved WVTR/OTR; WVTR of about 1×10⁻⁵ gm/m²/day and below can be achieved.

Nanoparticles meeting these specifications may be produced using the techniques and teachings of U.S. Patent Publication 2004/209,126 (Oct. 21, 2004), wherein a continuous film of aluminum oxynitride, silicon oxynitride, or silicon aluminum oxynitride is first deposited upon a carrier in the form of a suitable polymeric sheet or film using ion-assisted sputtering in the presence of an argon ion gun at a specified beam angle. In such a process, the thickness of the deposited layer can be carefully controlled, and the desired amorphous character of the nanoparticles can be achieved by controlling deposition conditions. A polymeric substrate or carrier is preferably chosen which has a surface that will relatively readily release the thin layer that is deposited; alternatively, the surface can be appropriately pretreated with a release coating to enhance release. Commercially available release coatings formed from styrene or acrylic resins or from blends thereof may be used.

As one embodiment of a suitable production process, deposition of an ultrathin barrier layer may take place on a film of polyethylene terephthalate (PET) having a thickness of about 125μ (5 mil); however, film thickness may vary so long as there is flexibility. The deposition conditions are carefully controlled so as to assure deposition of an oxynitride material of amorphous, noncrystalline character. To achieve this end, deposition is carried out in a suitable atmosphere of about 0.1 to about 0.5 millitorr using an argon ion gun at a beam half-angle of about 30°±5° and a voltage of between about 50 eV to 200 eV. Depending upon the substrate, it may be desirable to first bombard the polymer surface to provide a smooth surface from which release of the ultrathin material can be readily obtained. Such smoothing pretreatment of PET film, for example, may utilize an oxygen atmosphere of about 0.1-10 millitorrs with an ion gun grounded plasma at 50 to 250 eV. The temperature of the polymeric layer is preferably maintained at room temperature, as by cooling a drum on which the film is supported.

A sputtering process is used to supply the inorganic oxynitride vapor material, e.g., RF sputtering, mid-frequency sputtering, or Twin Mag sputtering. For example, sputtering using a standard magnetron cathode and an RF power of between about 200 to 600 watts might be used to bombard a target to vaporize an aluminum oxynitride and/or silicon oxynitride material of the desired approximate composition. Such sputtering creates a plasma of vaporized molecules that will reach the substrate. For the oxynitride deposition, the pressure in the deposition chamber should be maintained at about between 0.1 and 0.5 millitorr. Alternatively, elemental aluminum or silicon may be used as targets, and the residual atmosphere could be nitrous oxide (N₂O) or a mixture of nitrogen and oxygen at a ratio between about 3-8 to 1 atoms of nitrogen to atoms of oxygen. Other reactive conditions can also be employed to deposit silicon nitride or silicon oxynitride films. For example, U.S. Published Application 2005/100670 used trisilylamine and ammonia to deposit silicon nitride and TSA ammonia and oxygen to deposit silicon oxynitride. U.S. Published Application 2001/044220 deposited a silicon oxynitride layer using plasma-enhanced chemical vapor deposition from silane and nitrous oxide. The disclosures of these published applications are incorporated herein by reference. Coating with silicon aluminum oxynitride layers is taught in U.S. Pat. No. 6,495,251 using sputtering. Reactive deposition is preferably effected using sources of elemental silicon and aluminum where reaction occurs with oxygen and nitrogen ions in a plasma generated by an argon beam at the substrate surface, wherein the ratio of nitrogen atoms to oxygen atoms is preferably about 2 to 1. In applicants' process, the amorphous character of the oxynitride material being deposited is assured by monitoring the resultant product using X-ray diffraction.

A thin surface release layer of a material, such as DOW 685D, extrusion grade styrene resin, may be vapor-deposited onto the film prior to the deposition of the silicon aluminum oxynitride or silicon oxynitride layer of desired thickness, e.g. about 150-350 ANG. If such a release layer is used, it may be dissolved at any step during the following process using a suitable organic solvent for it to remove it from the ultrathin oxynitride deposit either before or after the deposit has been reduced in size to nanoparticle scale. Such size reduction may be carried out in any suitable manner known in the art, e.g. by grinding. The use of high speed rotating brushes has been found to be particularly effective in effecting release of the ultrathin deposit from the PET film. For example, brushes with brass bristles which are rotating at a speed of about 10,000 RPM can be used to scour the surface of such coated film material, causing the coating to be removed as flakes. Once removed, these particles may then be ground or air-milled, using known procedures, such as those taught in U.S. Pat. No. 6,863,851, to produce the minute nanoparticles of desired size, i.e. between about 100 and about 300 μm.

As an alternative to depositing the ultrathin oxynitride layer onto such a continuous length of polymeric film, it might be deposited onto the surface of a rotating drum from which it is then stripped and collected as generally known in this art. The surface of the drum could be continuously treated, if desired, by application of a release layer that might either simply remain on the drum surface or be stripped from along with the ultrathin deposit and then dissolved as in a solvent.

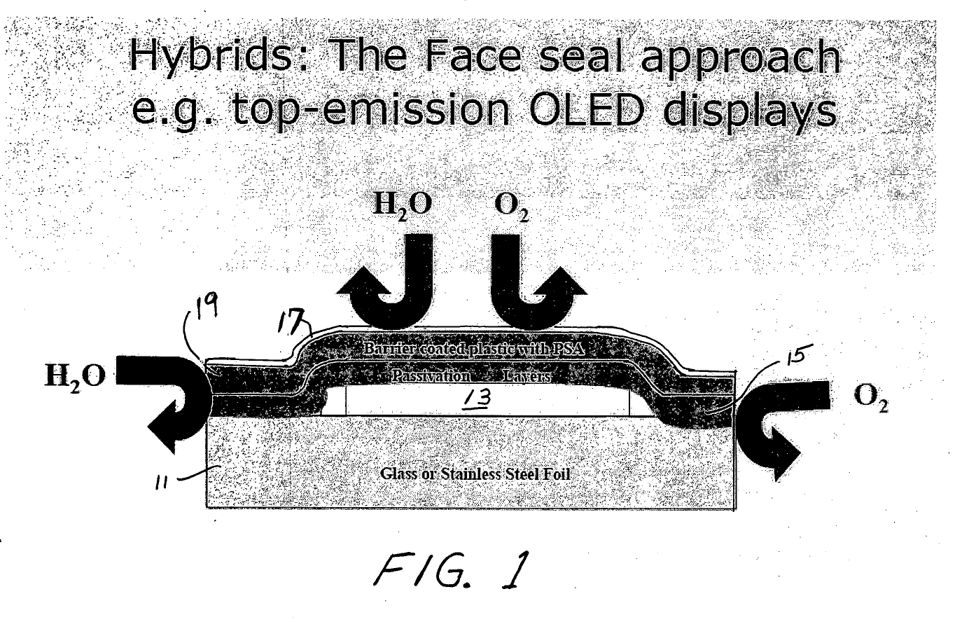

When these nanoparticles are used to create filled adhesive materials, the polymeric resins that are employed may be of suitable character for a particular application. For example, when the adhesive is one that is to be used to coat the entire surface of a barrier layer film that will be then used to protect a product such as that schematically shown in FIG. 1, so as to create a face seal, the adhesive chosen is advantageously one that is pressure-sensitive to afford easy application in making the ultimate product. FIG. 1 illustrates a substrate 11 which may be made of glass, stainless steel foil or any suitable material as well known in this art for this purpose, and the substrate may be either transparent or opaque so long as it allows substantially negligible transmission of water vapor and/or oxygen therethrough. Should flexibility desired, then a metal foil may be preferred. A light-emitting device 13, such as an OLED, is then built atop the substrate. As well known in the art, this light-emitting device 13 may include an anode, an organic light-emitting layer, which may include an organic hole-transporting layer in contact with the anode and an organic electron-transporting layer, and a cathode. When a face seal approach is to be employed, often an initial passivation or protective layer 15 is first deposited atop the subassembly of the substrate 11 and the light-emitting device 13. Such a protective layer 15 may be formed of silicon oxide, nitride, or oxynitride, of other metal oxides, or of organo or organo-metallic compounds; many such protective materials are well known in this art. Such a protective or passivation layer 15 is generally formed by chemical vapor deposition (CVD) or the like upon the subassembly.

When the face seal approach is used, a barrier layer 17 having a surface coated with pressure-sensitive adhesive (PSA) 19 is often applied atop the passivation layer 15 so as to envelope the entire upper surface of the subassembly, as shown in FIG. 1. The barrier layer 17 may be any single or multilayer coated polymeric film material. The film may be any of the suitable plastic materials being used for this purpose, such as PET, polyethylene naphthalate (PEN), polycarbonate (PC), polyethersulfone (PES), or polyfluoroethylene (PF). The film may have a thickness between about 25 μm and 175 μm, and commonly may have a thickness of about 125 μm. This film is barrier-coated with a thin layer that is highly resistant to transmission of water vapor and/or oxygen. Preferred are the barrier layer thin films marketed by General Atomics as their Super Sapphire single layer barriers which comprise coatings less than 1 micron thick of a metal oxide, metal nitride, or metal oxynitride. The PSA 19 that is used is preferably one that is radiation-curable, and particularly preferred are those which are UV radiation-curable. Such adhesives may be based on polyurethanes and/or polyacrylics, and there are numerous commercial adhesive formulators that market suitable PSAs, such as 3M Bonding Systems, Craig Adhesives and Coatings, Co., and Adhesives Research, Inc. For example, National Starch and Chemical Company markets hot melt and acrylic solution PSAs as well as acrylic/polyurethane PSAs.

These nanoparticles of such very high aspect ratio are suitably dispersed throughout the adhesive so as to preferably include them in a concentration between about 1% and about 5% by weight and more preferably, from about 1% to about 3% by weight; most preferably, the particles are effective at concentration of only about 1% to 2% by weight. Dispersion may be effected using any of the methods known throughout this art for particle dispersion generally; those taught in U.S. Pat. Nos. 6,080,350, and 6,226,890 are considered generally acceptable. A particularly preferable manner of dispersion is to dilute a pressure-sensitive adhesive with an appropriate solvent in order to reduce its viscosity to about 2,000 cps or less, and then disperse the nanoparticles by a sonification process. Once the nanoparticle dispersion has been achieved, the excess solvent may be evaporated.

When the filled adhesive material is to be used to create an edge seal as, for example, a bead between a pair of glass substrates, one might choose a thermosetting adhesive. There are a wide variety of thermosetting adhesives commercially available that may be employed. For example, epoxies, acrylates, methacrylates, silicones, cyclized polyisoprenes, modified polyvinyls and the like may be used. They may be two-part systems that cure upon mixing, which may employ a catalyst, or they may be compositions that are radiation-curable, e.g. UV-curable. For example, UV-curable acrylate adhesives are marketed by National Starch under their brand name Ablestik, that have been filled with these nanoparticles. It may also be possible to use adhesives from the group known as hot melt adhesives, which harden/cure upon reaching ambient temperature. If a two-part adhesive, for example an epoxy resin system, is employed, the nanoparticles may be dispersed throughout the less viscous component. As previously indicated, any of the foregoing adhesives or components thereof may be suitably diluted with an organic solvent in order to reduce the viscosity before dispersing the nanoparticles therein. Once dispersion has been achieved, the solvent can be easily removed by heating and/or degassing. In such an edge sealing approach, a bead or a layer of the filled adhesive is applied in the normal manner to create an edge seal that will be continuous about the periphery of the enclosure that is being sealed wherein the light-emitting device will be located. U.S. Pat. No. 6,740,145 illustrates an arrangement where a light-emitting device is sealed between two glass plates where such an edge seal might be used.

When a pressure sensitive adhesive (PSA) is being used to coat a barrier film to facilitate a face seal approach, the film is suitably coated either in roll or sheet form using any satisfactory coating method known in the art to apply a layer of PSA of desired thickness. If the film is only barrier-coated on one surface, the adhesive may be applied to either surface; however, it is preferably applied atop the barrier layer. For example, PSA coatings may be applied by spraying, solvent-coating, or by any of the methods used for making transparent tapes; however, the preferred method of coating with these filled adhesives for use in a face seal application is by spin coating the sheet material. Spin coating has been used for several decades to apply thin films; it typically involves depositing a small amount of a fluid resin onto the center of a substrate which is then spun at high speed, e.g. about 3,000 RPM. Centripetal acceleration causes the PSA to spread evenly to the edges of the substrate leaving a uniform thin film on the surface. This spreading movement tends to align the flat nanoparticles of such very high aspect ratio in an orientation generally parallel to the sheet surface and therefore tends to provide a particularly effective, tortuous barrier path through the adhesive layer. If such uniformly coated PSA/barrier films are not to be used directly, the tacky adhesive surface is covered with a thin release film, as is well known in this art. Other types of PSAs that do not exhibit a tack at about room temperature, but only at elevated temperatures, may be used that may not require covering by a release film. PSAs may also be formulated so as to be cured by the application of UV or other radiation.

As earlier mentioned, these nanoparticles of very high aspect ratio are also useful to create improved polymeric barrier sheets or films which are more effective than prior art films of this general type that included dispersed particles of desiccant or dispersed platelets of clay or the like. A wide variety of polymers may be used; particularly polyolefins, polyamides, and polyesters, such as PET or PEN, may be used. Polyethylene, polypropylene, and copolymers thereof are among the preferred polyolefins, and both high density and low density polyethylene may be used. Polyacrylonitrile and ethylene vinylalcohol copolymers, as well as polyvinylchlorides, may also be used to provide filled polymer sheets having improved barrier properties. Extrusion is a popular method for making such products by either dispersing the nanoparticles throughout the resin or intimately associating them therewith prior to feeding the resin to an extruder. Such films may vary in thickness depending upon their intended applications; however, films between about 25 μm and about 50 μm thick may be so filled to provide effective barriers. Such sheets and film exhibit substantially reduced permeability to gases, such as oxygen and water vapor, generally by at least about 30% and preferably by at least about 50% compared to the comparable unfilled polymer; often reductions in permeation of five-fold or more will be effected.

Because the nanoparticles are amorphous and nonpolar, they tend to fairly readily disperse in polymers, both in thermoplastic resins that can be extruded to form films, as well as in most polymeric adhesives. The nanoparticles may be homogeneously dispersed throughout the selected polymer using any of the procedures well known in the art for accomplishing such. For example, the procedures taught in U.S. Pat. No. 4,618,528 may be used where the raw materials, in substantially powder form, are thoroughly mixed prior to feeding to an extruder for extrusion of a film.

The following example sets forth one suitable procedure for the manufacture of nanoparticles embodying various features of the invention. A barrier material layer is first directly deposited upon the surface of a commercially available film, e.g. heat-stabilized PET having a thickness of about 125 microns (5 mil) which is sold by DuPont. The surface is first pretreated with an ion-beam generated plasma in the presence of oxygen. The pretreatment is carried out at a voltage between about 100 and 200 volts, i.e. at about 170 volts plus or minus 20 eV. The ion gun creating the plasma is located at about 3 to 5 inches from the surface of the film being treated, and the surface of the film is exposed to the oxygen ion-beam generated plasma for about 5 to 10 minutes. This pretreatment of the polymeric film under these conditions significantly reduces the surface roughness of the polymer on a nanoscale.

In one preferred embodiment, an inorganic barrier material layer is applied by argon beam ion-assisted sputtering an inorganic oxide, Al₂O₃, in an atmosphere containing nitrous oxide and nitrogen to deposit AlOₓN_{y}, where x is about 2.5 and y is about 2, under high vacuum conditions, i.e. about 0.5 millitorr or less. The argon ion gun is carefully controlled and oriented at a beam half-angle of about 30° in the ion-assisted deposition, which produces a pinhole-free layer. Conditions are carefully controlled to create a deposit on the moving film about 100 ANG in average thickness. Such deposition may be carried out continuously on a roll of PET film, for example, about 30 cm in width. The coated film may then be cut in sheets for removal of the deposited barrier layer, or the intact endless length may be treated with rapidly rotating brushes that will effectively flake the deposited aluminum oxynitride layer from the PET surface. The flakes are collected and subjected to air-milling to create nanoparticles of an average size of about 200 μm which, based upon their thickness will have an aspect ratio within the desired range of 3,000 to 50,000. These amorphous nanoflakes are then ready for dispersion in a polymeric adhesive to create a filled adhesive having a high WVTR/OTR; alternatively they may be incorporated into a polymeric resin for extrusion or the like to create sheet or film. Their use can result in the achievement of WVTRs and OTRs below levels previously achieved. WVTRs of 1×10⁻⁵ gm/m²/day and below may be achieved.

Although the invention has been described with regard to certain preferred embodiments which constitute the best mode known to the inventors, it should be understood that various changes and modifications as would be obvious to one having ordinary skill in this art may be made without departing from the scope of the invention, which is set forth in the claims appended hereto. The disclosures of all U.S. patents and U.S. publications that are set forth hereinbefore are expressly incorporated herein by reference.

Particular features of the invention are set forth in the claims which follow.

1. An adhesive having high resistance to gas diffusion, which adhesive comprises:
polymeric material having adhesive properties, and
nanoscale particles formed of amorphous aluminum oxynitrides, silicon oxynitrides, or silicon aluminum oxynitrides having an aspect ratio of between about 3,000 to 1 and about 50,000 to 1, dispersed substantially uniformly throughout said polymeric material.

2. The adhesive of claim 1 wherein said particles are present in such a quantity that the WVTR and the OTR of said sheetlike polymeric adhesive is reduced by at least about 30%.

3. The adhesive of claim 1 wherein said nanoscale particles are generally flat and have a thickness not greater than about 1,000 ANG.

4. The adhesive of claim 3 wherein said nanoscale particles have a thickness of between about 100 ANG and about 800 ANG.

5. The adhesive of claim 1 wherein said nanoscale particles consist essentially of AlOₓN_{y} where x is between 2.5 and 3 and y is between 1.5 and 2.

6. The adhesive of claim 1 wherein said nanoscale particles consist essentially of SiAlOₓN_{y} where x is between 2.5 and 3 and y is between 1.5 and 2 and wherein the molar ratio of silicon to aluminum is between about 1-1.25 to 1.

7. The adhesive of claim 1 wherein said particles are present in an amount between about 1% and about 5% by weight.

8. The adhesive of claim 1 wherein said polymeric material is a pressure sensitive adhesive.

9. The adhesive of claim 1 wherein said polymeric material is an epoxy resin.

10. A transparent polymeric gas diffusion barrier material, which material comprises:
sheetlike transparent polymeric material, and
nanoscale particles dispersed throughout said polymeric material,
said nanoparticles being formed of amorphous aluminum oxynitrides or silicon oxynitrides or a mixture thereof having an aspect ratio of between about 3,000 to 1 and about 50,000 to 1,
said nanoparticles being transparent to both visible and UV light, and
said nanoparticles being present in such a quantity that the WVTR and the OTR of said sheetlike polymeric material is reduced by at least about 30%.

11. The barrier material of claim 10 wherein the WVTR is not greater than about 1×10⁻⁵ gm/m²/day.

12. The barrier material of claim 10 wherein said nanoscale particles are generally flat and have a thickness not greater than about 1,000 ANG.

13. The barrier material of claim 12 wherein said nanoscale particles have a thickness of between about 100 ANG and about 800 ANG.

14. The barrier material of claim 10 wherein said nanoscale particles are primarily formed of AlOₓN_{y} where x is between 2.5 and 3 and y is between 1.5 and 2.

15. The barrier material of claim 10 wherein said particles are present in an amount between about 1% and about 3% by weight.

16. The barrier material of claim 10 wherein said polymeric material is selected from the group consisting of polyolefins, polyamides, polyesters, and copolymers thereof.

17. The barrier material of claim 16 wherein said sheetlike material is a film between about 25 μm and about 50 μm thick.

18. Particles useful in creating transparent polymeric gas diffusion barrier materials, which particles comprise:
nanoscale particles formed of amorphous aluminum and/or silicon oxynitrides having an aspect ratio of between about 3,000 to 1 and about 50,000 to 1, and a thickness between about 100 ANG and 1,000 ANG,
said particles being transparent to both visible and UV light and having no defined crystalline structure, and said particles when present in polymeric material in an amount of at least about 1 weight % causing the WVTR and the OTR of the polymeric material to be reduced by at least about 30%.

19. The particles of claim 18 which are primarily formed of AlOₓN_{y} where x is between 2.5 and 3 and y is between 1.5 and 2.

20. The particles of claim 19 which are vacuum-deposited using ion-assisted sputtering at a beam angle of about 30°±5°.
